(19) United States
(12) Patent Application Publication
(10) Pub. No.: US 2016/0364753 A1
(43) Pub. Date: Dec. 15, 2016

(54) RETARGETING BASED ON USER ITEM INTERACTIONS

(71) Applicant: eBay Inc., San Jose, CA (US)

(72) Inventor: Jian Zhang, Bellevue, WA (US)

(21) Appl. No.: 14/737,209

(22) Filed: Jun. 11, 2015

(51) Int. Cl. G06Q 30/02

(52) U.S. Cl. CPC G06Q 30/0255; G06Q 30/0275; G06Q 30/0277

(57) ABSTRACT

A community bidding engine for retargeting based on user interactions in a first online environment is provided. The community bidding engine generates a graph from a plurality of user interaction events between a plurality of users of the first online environment and a plurality of items presented within the first online environment. The graph includes a user node for each user of the plurality of users, an item node for each item of the plurality of items, and one or more edges. Each edge of the one or more edges connects a user node with an item node. The community bidding engine also determines a first community from the graph, the first community including a first user, determines a bid amount for the bid request based on the first community, and provides the bid amount for use with a bid request.

### TECHNICAL FIELD

Embodiments of the present disclosure relate generally to ad bidding in an online content system and, more particularly, but not by way of limitation, to retargeting of online advertisements based on user interactions with items in an online environment.

### BACKGROUND

Some online content providers or online advertising systems enable advertisers to bid for ad space in the content provider's online environment. For example, the online content provider may allow multiple advertisers to compete for a banner section of the content provider's web site, or a side advertisement on a user's social media page. Further, advertisers may bid for an ad impression served to a particular user.

### BRIEF DESCRIPTION OF THE DRAWINGS

Various ones of the appended drawings merely illustrate example embodiments of the present disclosure and cannot be considered as limiting its scope.

FIG. 1 illustrates a network diagram depicting an example retargeting system.

FIG. 2 is a block diagram showing components provided within the community bidding engine according to some embodiments.

FIG. 3 is a diagram illustrating item interaction events between a plurality of users, their associated devices, and a plurality of items provided through the marketplace application and the community bidding engine.

FIG. 4 illustrates an example user interactions graph generated by the community bidding engine shown in FIGS. 1-3 for the users, items, and item interactions shown in FIG. 3.

FIG. 5 is a diagram illustrating an example retargeting system that provides retargeting for online content items through a content provider.

FIG. 6 is a diagram of an example method for retargeting based on user interactions in an online environment using a user interactions graph own in FIG. 4 and associated communities shown in FIG. 4.

FIG. 7 is a block diagram illustrating a representative software architecture, which may be used in conjunction with various hardware architectures herein described.

FIG. 8 is a block diagram illustrating components of a machine, according to some example embodiments, able to read instructions from a machine-readable medium (e.g., a machine-readable storage medium) and perform any one or more of the methodologies discussed herein.

The headings provided herein are merely for convenience and do not necessarily affect the scope or meaning of the terms used. Like numbers in the Figures indicate like components.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

A community bidding engine and associated systems and methods for retargeting online content items (e.g., via advertisements) are described herein. The community bidding engine alleviates some of the problems discussed herein for at least some sellers or buyers, as well as yielding technical benefits to the functioning of the computer systems involved. User relevance of displayed content items, for example, may be important to advertisers because, in some advertising environments, advertising costs for some advertisers may be increased if the performance of past ads (e.g., click-through rate) is low. In other words, if an advertiser provides less-relevant ads that generate a click-through rate below a threshold, the content provider may charge that advertiser more for each impression (e.g., because they are making less on the lower click-throughs).

The community bidding engine manages bidding for online content (e.g., advertisements, or impressions) with external content providers or advertising systems. In some embodiments, the external content provider is a social media site in which a user is presented with online content including advertisements. The community bidding engine bids (e.g., in an auction with other potential advertisers) to present online content to the user through the content provider. The community bidding engine acts, inter alia, to maximize ad effectiveness and cost efficiency by identifying relevant content for the user via retargeting.

More specifically, and some embodiments, the community bidding engine identifies relevant content for the user based on that user's actions or activities in an online environment such as an online marketplace. The online marketplace may, for example, offer a variety of items for sale or auction. The user interacts with these items through the online marketplace via “item interaction events” (or just “item interactions”) such as, for example, clicking on an item (e.g., to see enhanced product detail for the item), or watching an item (e.g., marking an item for continued interest), or purchasing an item (e.g., completing a transaction for the item).

The community bidding engine examines item interaction events over many users and many items to form a bipartite graph (also referred to as a “user interactions graph”, or just “graph”), where users are represented as “nodes” (also referred to as “user nodes”) in the graph, items are represented as nodes (also referred to as “item nodes”) in the graph, and edges (also referred to as “interaction edges”) are defined between user nodes and item nodes based on the item interaction events of each user with the various items. In the example embodiment, each edge between a particular user and a particular item is weighted based on various factors associated with that user's interactions with that item. For example, a “heavier” (greater) weight is assigned to the edge if the user purchased that item, and a “lighter” (lesser) weight is assigned to the edge if the user merely clicked on the item without purchasing.

Once the user interactions graph is formed (e.g., with many users and many items), the community bidding engine determines “communities” (e.g., “clusters”) from the graph. A community represents a division or subset of the graph including some user nodes and some item nodes having strong relationships with each other. In other words, a community represent a particular subset of users having strong connections (e.g., heavier edges) with a particular subset of items. These communities within the graph have a tendency to indicate higher relevance of the items in the community to the users in the community.

Once the communities within the graph are identified, the community bidding engine uses the identified communities to bid on content serving to the user. For example, from past item interaction events, the user may have engaged with board games (e.g., viewing several board game items, purchasing board game items). As such, during the community determination, the user may be determined to be a part of, inter alia, a cluster of board game items and other users also having strong edges with board game items. During later online activity, the user visits their favorite social media provider (e.g., the content provider). As a part of the user's online visit, the content provider offers to show advertisement impressions to the user through a bidding process. The community bidding engine determines a bid price for the impression. In some embodiments, the community bidding engine determines a historic analysis of revenue per click for that community, and determines a bid for the impression based on that community's historical performance. In some embodiments, the community bidding engine determines an item from the community to present to the user within the impression. In some embodiments, the community bidding engine selects a community from a plurality of communities in which the user appears, and that selected community is used to bidding or item selection.

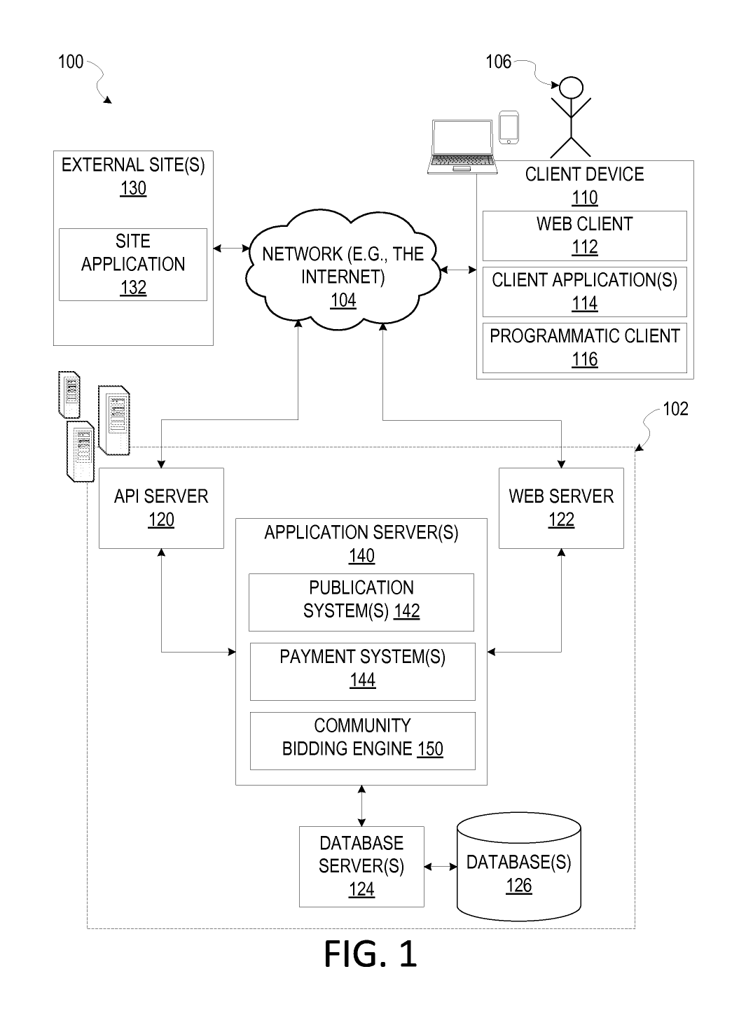

FIG. 1 illustrates a network diagram depicting an example retargeting system 100. In the example embodiment, the retargeting system 100 includes a community bidding engine 150 retargets online content items (e.g., advertisements) on an external site 130, such as a social media site (a “content site” selling ad impressions to online advertisers), based on item interaction events within an online environment having a plurality of items, such as an online marketplace, according to some embodiments.

A networked system 102 provides network-based, server-side functionality, via a network 104 (e.g., the Internet or Wide Area Network (WAN)), to one or more client devices 110 of a user 106 that may be used, for example, by sellers or buyers (not separately shown) of products and services offered for sale through a publication system 142 (e.g., a marketplace system). FIG. 1 further illustrates, for example, one or both of a web client 112 (e.g., a web browser), client application(s) 114, and a programmatic client 116 executing on client device 110.

Each of the client devices 110 comprises a computing device that includes at least a display and communication capabilities with the network 104 to access the networked system 102. The client device 110 includes devices such as, but not limited to, work stations, computers, general purpose computers, Internet appliances, hand-held devices, wireless devices, portable devices, wearable computers, cellular or mobile phones, portable digital assistants (PDAs), smart phones, tablets, ultrabooks, netbooks, laptops, desktops, multi-processor systems, microprocessor-based or programmable consumer electronics, game consoles, set-top boxes, network PCs, mini-computers, and the like. Each of the client devices 110 connects with the network 104 via a wired or wireless connection. For example, one or more portions of network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

Each of the client devices 110 includes one or more applications (also referred to as “apps”) 114 such as, but not limited to, a web browser, messaging application, electronic mail (email) application, an e-commerce site application (also referred to as a marketplace application), and the like. In some embodiments, if the e-commerce site application is included in a given one of the client devices 110, then this application is configured to locally provide the user interface and at least some of the functionalities with the application configured to communicate with the networked system 102, on an as needed basis, for data or processing capabilities not locally available (e.g., such as access to a database of items available for sale, to authenticate a user, to verify a method of payment). Conversely, if the e-commerce site application is not included in a given one of the client devices 110, the given one of the client devices 110 may use its web client 112 to access the e-commerce site (or a variant thereof) hosted on the networked system 102. Although only one client device 110 is shown in FIG. 1, two or more client devices 110 may be included in the retargeting system 100.

An Application Program Interface (API) server 120 and a web server 122 are coupled to, and provide programmatic and web interfaces respectively to, one or more application servers 140. In the example embodiment, the application servers 140 host the community bidding engine 150 that facilitates creating a user interactions graph, identifying communities within the graph, and bidding on ad impressions on the external site 130, as described herein. The application servers 140 are, in turn, shown to be coupled to one or more database servers 124 that facilitate access to one or more databases 126.

In some embodiments, the application servers 140 host one or more publication systems 142 and payment systems 144. The publication system 142, may provide a number of e-commerce functions and services to users that access networked system 102 and/or external sites 130. E-commerce functions/services may include a number of publisher functions and services (e.g., search, listing, content viewing, payment, etc.). For example, the publication system 142 may provide a number of services and functions to users for listing goods and/or services or offers for goods or services for sale, searching for goods and services, facilitating transactions, and reviewing and providing feedback about transactions and associated users. Additionally, the publication system 142 may track and store data and metadata relating to listings, transactions, and user interactions. In some embodiments, the publication system 142 may publish or otherwise provide access to content items stored in application servers 140 or databases 126 accessible to the application servers 140 or the database servers 124. The payment system 144 may likewise provide a number of payment services and functions to users. The payment system 144 may allow users to accumulate value (e.g., in a commercial currency, such as the U.S. dollar, or a proprietary currency, such as “points”) in accounts, and then later to redeem the accumulated value for products or items (e.g., goods or services) that are made available via the publication system 142. While the publication system 142 and payment system 144 are shown in FIG. 1 to both form part of the networked system 102, it will be appreciated that, in alternative embodiments, the payment system 144 may form part of a payment service that is separate and distinct from the networked system 102. In other embodiments, the payment system 144 may be omitted from the retargeting system 100. In some embodiments, at least a portion of the publication system 142 may be provided on the client devices 110.

Further, while the retargeting system 100 shown in FIG. 1 employs a client-server architecture, embodiments of the present disclosure are not limited to such an architecture, and may equally well find application in, for example, a distributed or peer-to-peer architecture system. The various publication and payment systems 142 and 144 may also be implemented as standalone software programs, which do not necessarily have networking capabilities.

The client devices 110 access the various publication and payment systems 142 and 144 via the web interface supported by the web server 122. Similarly, the programmatic client 116 accesses the various services and functions provided by the publication and payment systems 142 and 144 via the programmatic interface provided by the API server 120. The programmatic client 116 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 116 and the networked system 102.

In the example embodiment, the community bidding engine 150 identifies item interaction events between users 106 (e.g., via client devices 110) and items (not shown in FIG. 1) offered for sale via the publication system 142. In some embodiments, the item interaction events are stored in the database 126. The community bidding engine 150 generates a bipartite graph, or “user interactions graph” for a plurality of users and a plurality of items based on the item interaction events. From the graph, the community bidding engine 150 identifies communities, or clusters, associated with a subset of users and a subset of items. Subsequently, the user 106 may visit the external site 130, and the external site 130 may offer to present impressions, or “ads”, to the user during their online visit. The community bidding engine 150 generates a bid for the user based on the communities to which the user belongs.

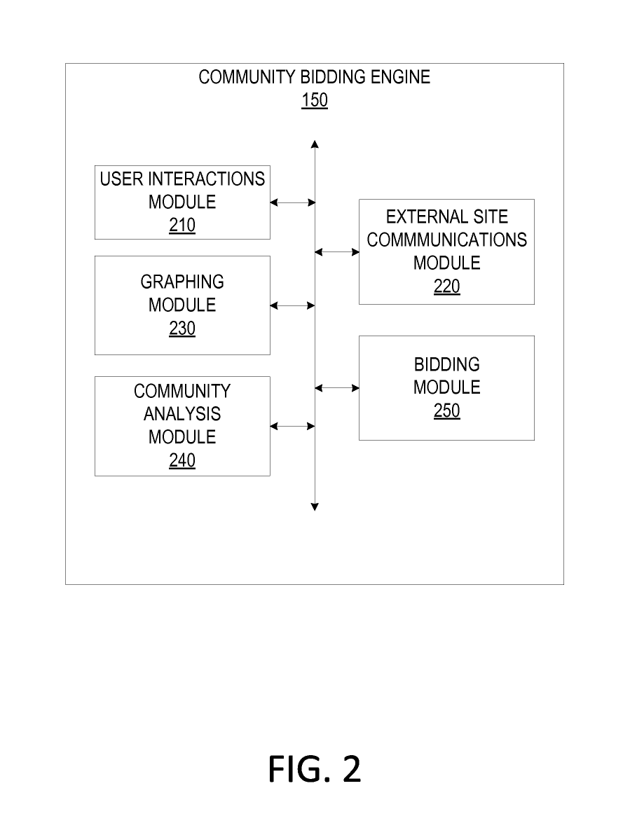

FIG. 2 is a block diagram showing components provided within the community bidding engine 150 according to some embodiments. The community bidding engine 150 may be hosted on dedicated or shared server machines (not shown) that are communicatively coupled to enable communications between server machines. The components themselves are communicatively coupled (e.g., via appropriate interfaces) to each other and to various data sources, so as to allow information to be passed between the applications or so as to allow the applications to share and access common data. Furthermore, the components may access one or more databases 126 via the database servers 124 (both shown in FIG. 1).

The community bidding engine 150 provides a number of graphing and bidding methanisms whereby the community bidding engine 150 analyzes and graphs item interaction events between users and items in an online environment such as an e-commerce marketplace, determine communities or clusters of users and items based on the graph, and use the graph to bid on advertising impressions offered by a content provider.

To this end, the example community bidding engine 150 includes a user interactions module 210, an external site communications module 220, a graphing module 230, a community analysis module 240, and a bidding module 250.

In the example embodiment, the user interactions module 210 identifies user interaction events occurring in an online environment between users 106 (e.g., via client devices 110) of the online environment and items (not shown in FIG. 2) presented within the online environment. In some embodiments, the online environment is an online e-commerce marketplace such as the publication system 142 or a third party marketplace supported by an external site 130.

The users 106 interact with items through the online environment through one or more types of user interaction (or “user interaction types”). In the example embodiment, the publication system 142 offers items for sale to the users 106. Further, the publication system 142 provides several different types of user interaction that the users 106 may have with the items. For example, the publication system 142 provides one or more of a viewing interaction, a watching interaction, a bidding interaction, a purchase interaction, an impression interaction, an “add-to-cart” interaction, and an asking interaction. The viewing interaction (also sometimes referred to herein as “clicking”) represents when a user views or investigates details of an item, such as, for example, clicking on an item from a list in order to see more detailed information about the item. The watching interaction represents, for example, when a user marks a particular item for continued tracking, or “watching.” The bidding interaction represents, for example, when a user enters a bid on the item (e.g., in an auction). The purchase interaction represents, for example, when a user consummates or completes a transaction for the item. The impression interaction represents, for example, when a user performs a search (e.g., using one or more keywords) and the item is in a list of search results generated (e.g., the user interacts with the item through at least the search results page displayed to the user, which has a subset of details or information about the item and, as such, the user receives an impression of the item). The add-to-cart interaction represents, for example, when a user adds a particular item to their online e-commerce “cart,” or their virtual shopping inventory (e.g., for purchase). The asking interaction represents, for example, submitting a question to a seller of an item (e.g., inquiring as to further item details or purchase specifics). Other types of item interactions may be possible, and are within the scope of this disclosure.

Some types of item interactions may be based on the particular online environment in which the items are presented. For example, in an Internet-based digital distribution and digital rights management environment, in which the user may purchase, gift, or use items (e.g., software titles), item interaction types include some or all of the above item interaction types, as well as optionally a purchase-for-another interaction (e.g., completing a purchase, but for ownership by another as a gift), a review interaction (e.g., entering a quality review of the item), a reading reviews interaction (e.g., viewing reviews of the item), a related items interaction (e.g., viewing an item from a list of items related to the primary item), and a play interaction (e.g., executing an already-owned software title). For another example, in an online digital music marketplace, in addition to some or all of the above-mentioned item interaction types, additional item interaction types may also include a listening interaction (e.g., listening to a segment of a song).

Each of these types of user interaction with an item may indicate heightened interest by the user in that item, and perhaps to varying degrees. In the example embodiment, a graphing module 230 creates a bipartite graph, or “user interactions graph,” (not shown in FIG. 2) based on the user interactions collected by the user interactions module 210. The graph contains a first set of nodes representing a plurality of users (e.g., each “user node” representing a single user of the online environment in which the items appear) and a second set of nodes representing items (e.g., each “item node” representing a single item (or group of items) appearing in the online environment). As such, the graphing module 230 generates these two sets of nodes within the graph.

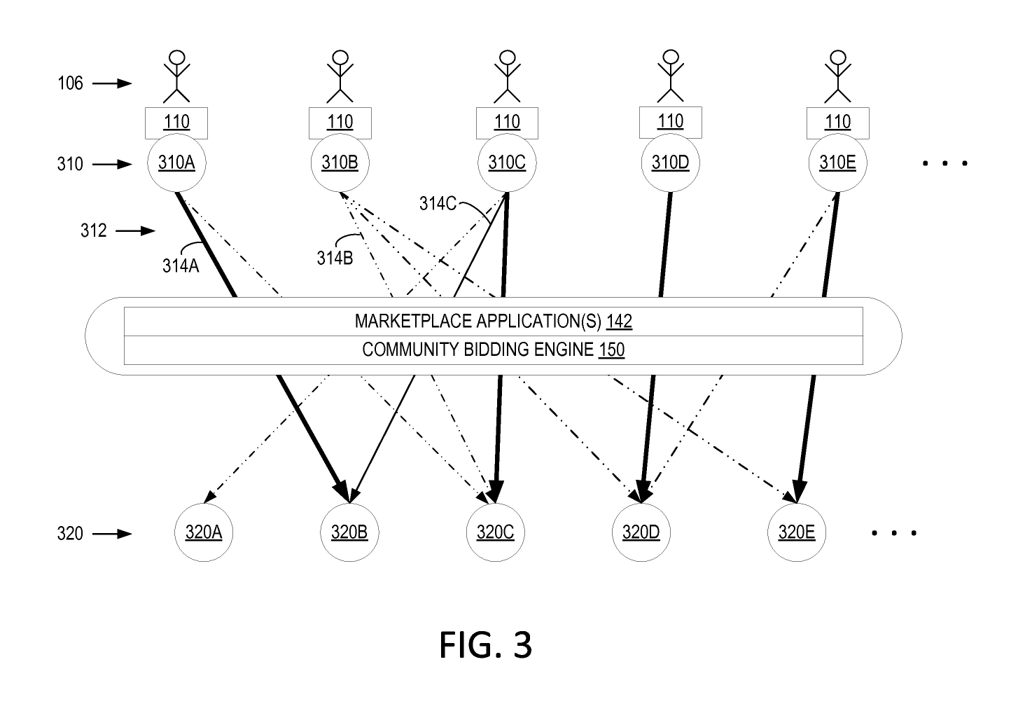

Further, in the example embodiment, the graphing module 230 also creates a plurality of edges, or “interaction edges”, where each edge involves or “connects” exactly one user node with exactly one item node. Each edge includes an “edge weight” (or just “weight”) based on the associated user's interaction events with the associated item. The graphing module 230 computes these edge weights from the user interaction events. Creation of the user interactions graph is discussed in greater detail below with respect to FIG. 3.

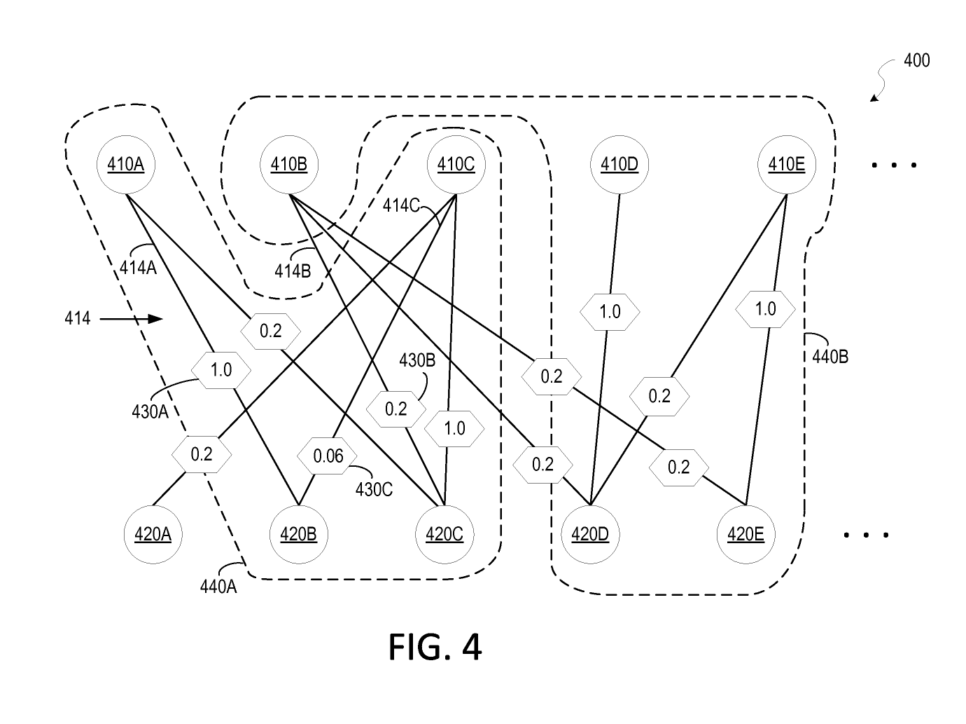

In the example embodiment, the community analysis module 240 determines one or more “communities” or “clusters” from the user interactions graph created by the graphing module 230. Each community includes a first subset of users (e.g., of all of the users in the graph) and a first subset of items (e.g., of all of the items in the graph), as well as their associated edges. The determination of communities from the user interactions graph is discussed in greater detail below with respect to FIG. 4.

The bidding module 250, in the example embodiment, generates bids for advertising or impressions based on the determined communities. For example, when a particular user who has a user node in the graph visits the external site 130, the external site 130 accepts bids from the community bidding engine 150 and perhaps other advertisers. The bidding module 250 identifies the particular user and one or more communities to which the user belongs. The bidding module 250 then generates a bid to serve an advertisement to that user based on one or more of the associated communities, as well as identifying a particular item to advertise to that user through the external site 130. Bidding and item selection are discussed in greater detail below.

In the example embodiment, the external site communications module 220 performs communications with the external sites 130 such as, for example, submitting the bids generated by the bidding module 250 and transmitting item data to the external sites 130 for use in presenting the advertisements in winning bids.

FIG. 3 is a diagram illustrating item interaction events between a plurality of users 106 (and their associated devices 110) and a plurality of items 320 provided through the publication system 142 and the community bidding engine 150. In the example embodiment, individual users are represented as users 310A, 310B, 310C, 310D, and 310E (collectively, “users 310”) in FIG. 3, and individual items presented by the online environment (e.g., the publication system 142) are represented as items 320A, 320B, 320C, 320D, and 320E (collectively, “items 320”) in FIG. 3. It should be understood that only five users 310 and five items 320 are shown in FIG. 3 for purposes of illustrative convenience, and that any number of users 310 and items 320 are possible. Further, it should be understood that the publication system 142 is illustrated as the “online environment” in this example (e.g., the online setting in which the items 320 occur and are subject to item interaction events from the users 310) but, as discussed above, other online environments are possible. For example, the online environment may be another e-commerce marketplace hosted by the external site 130.

In the example embodiment, the users 310 interact with the items 320 through the publication system 142. Each user interaction (or “interaction event”) 312 with an item, such as the item 320A, is represented in FIG. 3 by a line connecting the acting user 310 with the subject item 320. In the example shown in FIG. 3, three types of interactions 314A, 314B, and 314C (collectively, “item interaction types 314”) are shown for purposes of illustration. As mentioned above, additional or other interaction types are possible. Purchase type interactions 314A are represented by thick solid lines. View type interactions 314B are represented by broken lines (e.g., dash, dot, dot). Watch type interactions 314C are represented by thin solid lines.

In the example embodiment, each individual user 310 interacts with one or more items 320, and these item interactions 312 are tracked and stored (e.g., by the community bidding engine 150 at the time of their occurrence, or by log files associated with the publication system 142). For example, the user 310A performs a purchase type interaction 314A with the item 320B and a view type interaction 314B with the item 320C. Similarly, the user 310B performs view type interactions 314B with the items 320C, 320D, and 320E, and the user 310C performs a view type interaction 314B with the item 320A, a watch type action 314C with the item 320B, and a purchase type interaction 314A with the item 320C. The user 310D performs a purchase type transaction 314A with the item 320D, and the user 310E performs a purchase type transaction 314A with the item 320E and a view type interaction 314B with the item 320D. Community bidding engine 150 generates a user interactions graph (not shown in FIG. 3) that includes the users 310, the items 320, and the item interactions 312.

In the example shown in FIG. 3, only a single item interaction 312 is shown between a particular user 310 and a particular item 320 (e.g., a most recent item interaction, or a highest weighted or most significant item interaction, or a highest weighted item interaction within a last pre-determined period of time, such as the last month). In some embodiments, individual users 310 may generate multiple item interactions 312 with the same item (not separately shown). For example, an individual user such as user 310A may perform a view type interaction and a watch type interaction with a particular item (e.g., item 320A) in one session (e.g., with the publication system 142) and may return some time later and perform another view type interaction and a purchase type interaction with the same item 320A in another session.

FIG. 4 illustrates an example user interactions graph 400 generated by the community bidding engine 150 for the users 310, items 320, and item interactions 312. In the example embodiment, each user 310 is represented by a user node 410A, 410B, 410C, 410D, and 410E (collectively, “user nodes 410”). For example, the user 310A is represented in the graph 400 as user node 410A, the user 310B is represented in the graph 400 as user node 410B, and so on. Similarly, each item 320 is represented by an item node 420A, 420B, 420C, 420D, and 420E (collectively, “item nodes 420”). For example, the item 420A is represented in the the graph 400 as item node 420A, the item 420B is represented in the graph 400 as item node 420B, and so on.

In the example embodiment, the graph 400 includes a plurality of edges 412. In FIG. 4, each edge 414 is represented as a line between a single user node 410 and a single item node 420. Each individual edge 414 also includes a weight such as weights 430A, 430B, and 430C (collectively, “weights 430”), making the example graph 400 a “weighted graph”. The weights 430 are illustrated in FIG. 4 overlayed over the edge 414 to which they belong. In FIG. 4, only three weights 430 are individually numbered for ease of illustration.

In the example embodiment, the community bidding engine 150 determines the weights 430 for each edge 414 in the graph 400 based on the item interactions 312 between the users 310 (e.g., between user nodes 410) and the items 320 (e.g., between item nodes 420). In some embodiments, the weights 430 are determined based on the item interaction types 314. In one embodiment, each item interaction type is assigned a weight value. For example, the purchase interaction type 314A may include a weight value of 1.0, the view interaction type 314B may include a weight value of 0.2, and the watch interaction type 314C may include a weight value of 0.06. As such, the edge 414A is assigned the weight 430A of 1.0, the edge 414B is assigned the weight 430B of 0.2, and the edge 414C is assigned the weight 430C of 0.06.

In some embodiments, the user 310A (e.g., user node 410A) may interact with an item 320B (e.g., the item node 420B) several times. For example, the user may generate a view type event 314B, then a watch type event 314C before performing a purchase type event 314A. In some embodiments, the community bidding engine 150 may assign the weight value associated with the highest weighted interaction type performed by the user with that item to the associated edge. Continuing the example, the highest weighted interaction type performed by the user 310A (e.g., the user node 410A) with the item 320B (e.g., the item node 420B) is the purchase type event 314A. As such, the community bidding engine 150 assigns the weight value associated with the purchase type event 314A of 1.0 to the edge 414A. In one embodiment, the highest weighted interaction type performed by the user with that item during a single session is assigned to the associated edge. A “session” may be, for example, the time between when the user logs into the publication system 142 and when they log out.

In other embodiments, the community bidding engine 150 generates a weight for edges based on the following operations. First, for each given interaction between a particular user (e.g., the user 310A, the user node 410A) and a particular item (e.g., the item 320B, the item node 420B), the highest weighted interation type performed by that user during the session (e.g., a “session weight”) is identified for that session (similar to as described above). When there are multiple sessions (e.g., within a pre-determined period of time, such as weekly), the highest “session weight” for each session are accumulated, or added together, to generate a “periodic weight” (e.g., a weekly weight) for that edge. In some embodiments, when there are past periodic weights (e.g., past weekly weights) for that same edge, the past periodic weights are added together with the current periodic weight to generate a total weight for the edge. In some embodiments, past periodic weights are degraded or decayed prior to generating the total weight. In one embodiment, the periodic weights are decayed by half for each past period. For example, a current weekly weight is not decayed at all (e.g., full value), last week's weight is decayed by half (e.g., half its full value), a prior week's weight is decayed by a fourth (e.g., 0.25*its full value), and so forth. As such, more current item interaction events weigh more heavily than older item interaction events.

In other embodiments, the weights 430 are determined based on a number of interactions 312 between the associated user and item. For example, the community bidding engine 150 may count a total number of interaction events between the user 310A (e.g., user node 410A) and the item 320B (e.g., item node 420B) and assign that integer as the weight 430A of edge 414A. In some embodiments, the total may be “windowed”, or counted only within the past pre-determined time (e.g., a total number of interaction events within a last number of days, number of weeks, or number of months).

The graph 400, in the example embodiment, is represented as a matrix (not shown) or array data structure (e.g., within memory of networked system 102), wherein each row of the matrix represents a particular user node 410, wherein each column of the matrix represents a particular item node 420, and wherein the cell value at a particular row and column of the matrix represents the weight 430 of the edge between the associated user node 410 and the associated item node 420. In other embodiments, other internal representations of graph 400 may be used.

In the example embodiment, the community bidding engine 150 determines one or more communities 440A, 440B (collectively, “communities 440”) from the graph 400 based on the edge weights 430. In some embodiments, the community bidding engine 150 finds cut points that define minimum cross-community interactions related to the density of communities. These computations may be performed using the above-described matrix representation of the graph 400. In some embodiments, the community bidding engine 150 determines the communities 440 from the graph 400 using known cluster analysis or “clustering” algorithms or applications such as, for example, iGraph (available at http://igraph.org).

The problem may be formulated as such: given a set of m rows in n columns (e.g., an m by n matrix), the community bidding engine 150 generates “biclusters” or a subset of rows which exhibit similar behavior across a subset of columns, or vice versa. For example, the matrix may be reordered (e.g., the rows or columns may be reordered) such as to group together similar rows/columns and find biclusters with similar values.

In the example embodiment, the community bidding engine 150 determines two communities 440A and 440B involving the user nodes 410 and the item nodes 420 illustrated in FIG. 4. For example, the community 440A includes the user nodes 410A and 410C and item nodes 420B and 420C. This community 440A represents closely related users and items as illustrated and determined by the edge weights joining the user nodes and item nodes. Similarly, the community 440B represents closely related the user nodes 410B, 410D, and 410E and the item nodes 420D and 420E.

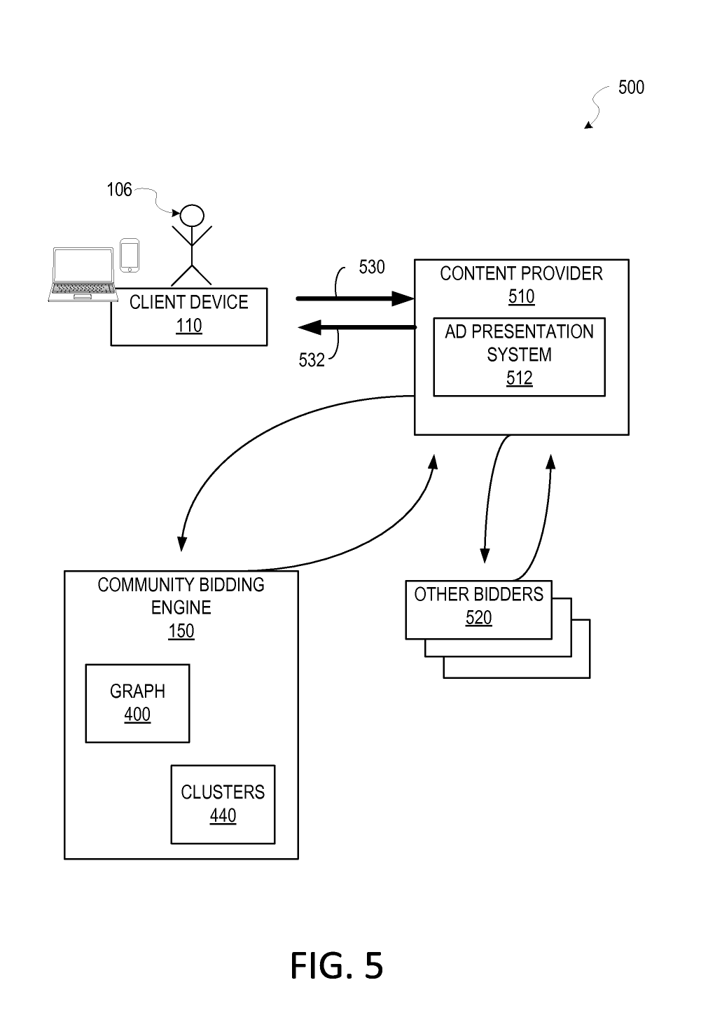

FIG. 5 is a diagram illustrating an example retargeting system 500 that provides retargeting for online content items through a content provider 510. In some embodiments, the content provider 510 may be similar to the external site 130 and may be, for example, a social media site or other web site providing online content to a client device 110 of a user 106. The content provider 510 includes an ad presentation system 512 which provides online content to the user 106, including online content items (e.g., advertisements) from a plurality of content providers (e.g., advertisers) such as the community bidding engine 150 and other bidders 520.

Prior to the actions shown and described here in relation to FIG. 5, the user 106 interacts with an online environment (e.g., publication system 142) as shown and described above (not separately shown in FIG. 5). The community bidding engine 150 generates the user interactions graph 400 and the communities 440, as shown and described above. As such, the graph 400 is based at least in part on the interactions of the user 106, and one or more of the communities 440 include a user node for the user 106.

During operation, and as shown here in relation to FIG. 5, the user 106 (e.g., via the client device 110) engages the content provider 510 during online use. For example, the content provider 510 may be a social media site, and the user 106 may log onto their account on the social media site. During online use, the client device 110 interacts with the content provider 510 (e.g., via a request for content 530). The user 106 or client device 110 is identified or identifiable to the content provider 510 (e.g., via a login identifier, a cookie), and at least some part of the content provided to the user 106 includes an online content item (e.g., an advertisement) to display to the user 106. For example, the client device 110 may request a home page (not shown) for the social media site of the user 106, and that home page may include a presentation area reserved for advertisements to show to the user 106.

To populate the advertisement, the ad presentation system 512 accepts bids from one or more advertisers or bidders such as the community bidding engine 150 and one or more other bidders 520. The ad presentation system 512 provides identification of the user 106 or other identifying information for the user 106 to the community bidding engine 150. For example, during prior interaction between the user 106 and the publication system 142, the client device 110 may have received a cookie identifying the user 106. In some embodiments, this cookie also identifies one or more communities or clusters for the associated user 106, as described above. During the bidding shown in FIG. 5, the content provider 510 may access the cookie associated with the publication system 142 from the client device 110, thereby identifying the user 106 (and the particular user node 310 of the user 106) to the community bidding engine 150, or to the content provider 510. In some embodiments, the one or more communities of the user 106 may also be identified from the cookie. In other embodiments, the user 106 may be identified from the cookie, and the communities may be identified from the graph 400.

In some embodiments, the community bidding engine 150 uploads one or more community bid mappings to the content provider 510 or the ad presentation system 512. Each community bid mapping identifies a community and a bid value associated with that community (e.g., a value that the community bidding engine 150 is willing to enter for that community). As such, the content provider 510 or the ad presentation system 512 may identify a bid associated with the user 106 from the community bid mapping immediately (e.g., may not need to communicate with the community bidding engine 150 for each individual bid). For example, the community bidding engine 150 generates a plurality of community bid mappings on a periodic basis such as, for example, hourly, daily, or weekly, and transmits the community bid mappings to the content provider 510, the ad presentation system 512, or some third party ads system similarly soliciting bids for ads.

As such, the community bidding engine 150 determines which user 310 or user node 410 of the graph 400 is associated with the requesting user 106. Having identified the user node 410 associated with the user 106, the community bidding engine 150 identifies one or more communities 440 associated with the user 106 (e.g., communities 440 in which the user node appears). Presume, for example, that the user 106 is user 310D, and is thus associated with the user node 410D. As shown in FIG. 4, this user node 410D is in the community 440B, along with the user nodes 410B and 410E, and the item nodes 420D and 420E, as shown in FIG. 4. A single “target community” (e.g., community 440B) is selected by the community bidding engine 150.

The community bidding engine 150 determines a bid price for the ad bid. In some embodiments, the bid price is determined based on the identified target community, such as the community 440B. For example, the community bidding engine 150 identifies historical performance data associated with the target community 440B such as, for example, revenue per impression served, or revenue per click, for past impressions served for the items 420D and 420E. The historical performance data is used to determine the bid price for the current impression.

For example, presume that a community “C1” has received 1,000 click events that generated $X over the past two weeks. As such, the revenue per click is $X divided by 1,000. A ratio is identified, for example, to meet a particular pre-determined budget, such that the bid amount for a community C1 bid is the ratio times the revenue per click. In some embodiments, when the actual expense or cost exceeds the budget (e.g., exceeded by 10% on day #1), then on the next day, the ratio may be additionally reduced based on the overage expense from the previous day.

In some embodiments, the community bidding engine 150 identifies a particular “target item” (e.g., item node 420E) within the target community (e.g., the community 440D). The target item represents the item for which the advertisement or impression will focus (e.g., what will be advertised to the user 106, should the community bidding engine 150 win the bid). The user 106 may or may not have previously intereacted with the target item. For example, the item node 420E is included in the target community 440B, and may be identified for this impression even though the user node 410D has no prior interaction events (e.g., weight of 0.0) with the item node 420E.

In the example illustrated in FIG. 5, the community bidding engine 150 is shown interacting directly with the content provider 510 and the ad presentation system 512 to bid for impressions to serve to user 106 (e.g., via response 532). In other embodiments, the content provider 510 may, as is commonly know in the field, use a third party system (not shown) for providing advertisements served by the content provider 510, and the third party system may perform the bidding interactions (e.g., with the community bidding engine 150 and other bidders 520). Any such architecture that enables the systems and methods described herein may be used.

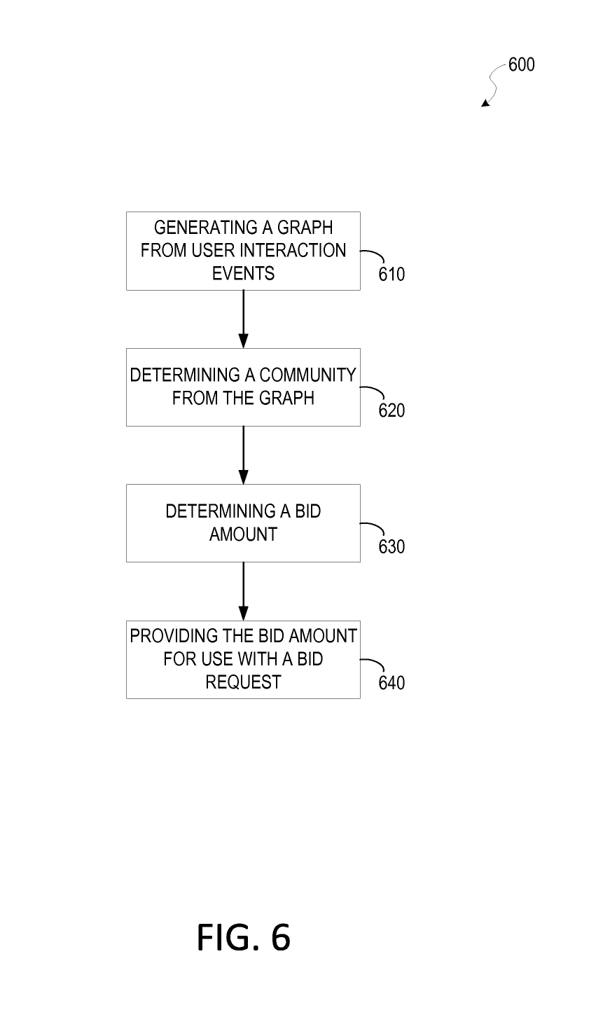

FIG. 6 is a diagram of an example method 600 for retargeting based on user interactions in an online environment using the user interactions graph 400 and the associated communities 440. In the example embodiment, the method 600 is performed by a computing device including a processor and memory which may be similar to the community bidding engine 150. In operation 610, a graph is generated 610 from a plurality of user interaction events between a plurality of users of the first online environment and a plurality of items presented within the first online environment. The graph includes a user node for each user of the plurality of users, an item node for each item of the plurality of items, and one or more edges. Each edge of the one or more edges connects a user node with an item node. In some embodiments, operation 610 further includes computing a first edge weight for a first edge of the one or more edges based on the plurality of user interaction events, wherein determining the first community from the graph further includes determining the first community based at least in part on the first edge weight. In some embodiments, computing the first edge weight includes computing the first edge weight based on a first user interaction event involving the first user, whereby the first user interaction event has a first user interaction event type. The first edge weight may be defined by a first pre-defined weight associated with the first user interaction event type.

In the example embodiment, a first community is determined from the graph in operation 620, whereby the first community includes a first user.

In operation 630, a bid amount for the bid request is determined based on the first community. In some embodiments, operation 530 further includes determining the bid amount based on historical revenue data associated with the first community.

In the example embodiment, the bid amount is provided for use with a bid request for serving an online content item to the first user within a second online environment of a content provider in operation 640. In some embodiments, the method 600 also includes determining a first item from the first community, and identifying the first item for retargeting to the first user through the online content item when the bid request is won by the community bidding engine. In some embodiments, the method 600 includes receiving a bid request associated with the serving the online content item to the first user, wherein operation 640 includes transmitting the bid amount in response to the bid request. In some embodiments, operation 640 includes transmitting, prior to the bid request, a community bid mapping to an advertising system associated with the bid request. The community bid mapping identifies the first community and a first bid value associated with the first community, whereby the first bid value identifies the bid amount.

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

The modules, methods, applications and so forth described in conjunction with FIGS. 1-6 are implemented in some embodiments in the context of a machine and an associated software architecture. The sections below describe representative software architecture(s) and machine (e.g., hardware) architecture that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things.” While yet another combination produces a server computer for use within a cloud computing architecture. Not all combinations of such software and hardware architectures are presented here as those of skill in the art can readily understand how to implement the invention in different contexts from the disclosure contained herein.

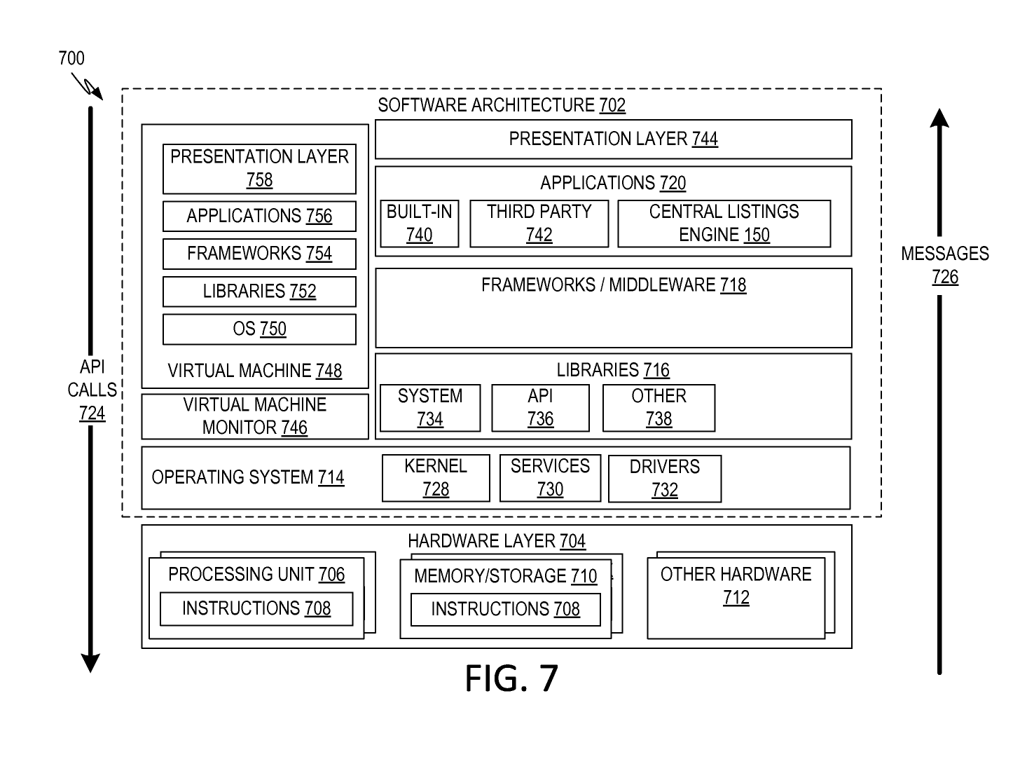

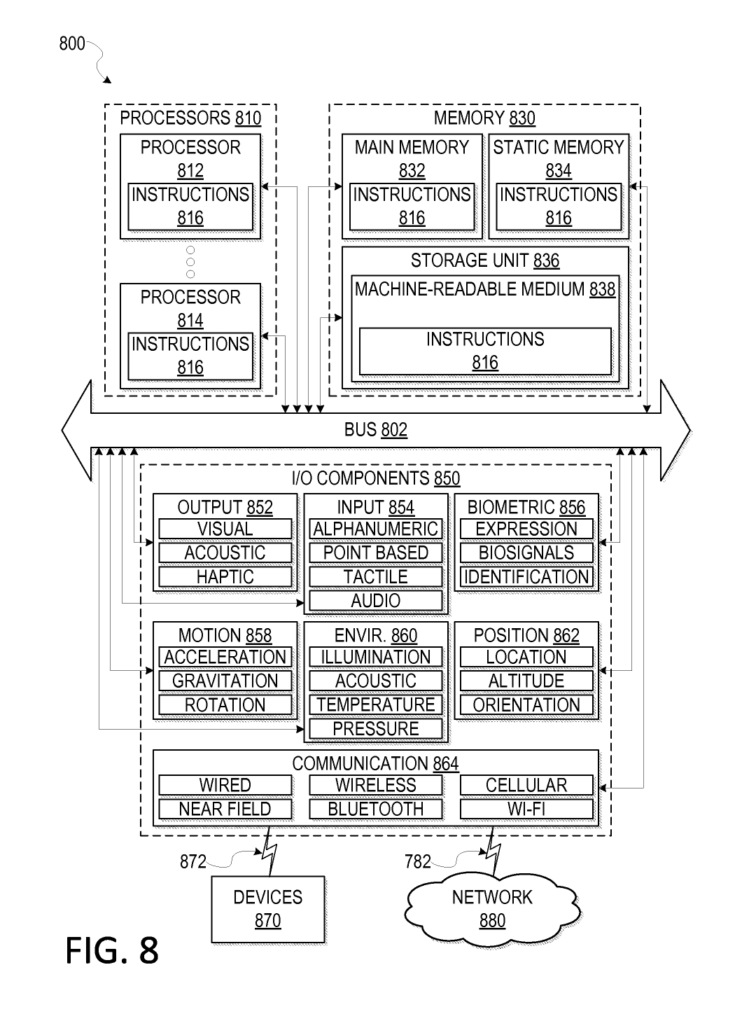

FIG. 7 is a block diagram 700 illustrating a representative software architecture 702, which may be used in conjunction with various hardware architectures herein described. FIG. 7 is merely a non-limiting example of a software architecture and it will be appreciated that many other architectures may be implemented to facilitate the functionality described herein. The software architecture 702 may be executing on hardware such as machine 800 of FIG. 8 that includes, among other things, processors 810, memory 830, and I/O components 850. A representative hardware layer 704 is illustrated and can represent, for example, the machine 800 of FIG. 8. The representative hardware layer 704 comprises one or more processing units 706 having associated executable instructions 708. Executable instructions 708 represent the executable instructions of the software architecture 702, including implementation of the methods, modules and so forth of FIGS. 1-6. Hardware layer 704 also includes memory or storage modules 710, which also have executable instructions 708. Hardware layer 704 may also comprise other hardware as indicated by 712 which represents any other hardware of the hardware layer 704, such as the other hardware illustrated as part of machine 800.

In the example architecture of FIG. 7, the software 702 may be conceptualized as a stack of layers where each layer provides particular functionality. For example, the software 702 may include layers such as an operating system 714, libraries 716, frameworks/middleware 718, applications 720 and presentation layer 622. Operationally, the applications 720 or other components within the layers may invoke application programming interface (API) calls 724 through the software stack and receive a response, returned values, and so forth illustrated as messages 726 in response to the API calls 724. The layers illustrated are representative in nature and not all software architectures have all layers. For example, some mobile or special purpose operating systems may not provide a frameworks/middleware layer 718, while others may provide such a layer. Other software architectures may include additional or different layers.

The operating system 714 may manage hardware resources and provide common services. The operating system 714 may include, for example, a kernel 728, services 730, and drivers 732. The kernel 728 may act as an abstraction layer between the hardware and the other software layers. For example, the kernel 728 may be responsible for memory management, processor management (e.g., scheduling), component management, networking, security settings, and so on. The services 730 may provide other common services for the other software layers. The drivers 732 may be responsible for controlling or interfacing with the underlying hardware. For instance, the drivers 732 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 716 may provide a common infrastructure that may be utilized by the applications 720 or other components or layers. The libraries 716 typically provide functionality that allows other software modules to perform tasks in an easier fashion than to interface directly with the underlying operating system 714 functionality (e.g., kernel 728, services 730 or drivers 732). The libraries 716 may include system 734 libraries (e.g., C standard library) that may provide functions such as memory allocation functions, string manipulation functions, mathematic functions, and the like. In addition, the libraries 716 may include API libraries 736 such as media libraries (e.g., libraries to support presentation and manipulation of various media format such as MPREG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 716 may also include a wide variety of other libraries 738 to provide many other APIs to the applications 720 and other software components/modules.

The frameworks 718 (also sometimes referred to as middleware) may provide a higher-level common infrastructure that may be utilized by the applications 720 or other software components/modules. For example, the frameworks 718 may provide various graphic user interface (GUI) functions, high-level resource management, high-level location services, and so forth. The frameworks 718 may provide a broad spectrum of other APIs that may be utilized by the applications 720 or other software components/modules, some of which may be specific to a particular operating system or platform.

The applications 720 includes built-in applications 740 or third party applications 742. Examples of representative built-in applications 740 may include, but are not limited to, a contacts application, a browser application, a book reader application, a location application, a media application, a messaging application, or a game application. Third party applications 742 may include any of the built in applications as well as a broad assortment of other applications. In a specific example, the third party application 742 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third party application 742 may invoke the API calls 724 provided by the mobile operating system such as operating system 714 to facilitate functionality described herein.

The applications 720 may utilize built in operating system functions (e.g., kernel 728, services 730 or drivers 732), libraries (e.g., system 734, APIs 736, and other libraries 738), frameworks/middleware 718 to create user interfaces to interact with users of the system. Alternatively, or additionally, in some systems interactions with a user may occur through a presentation layer, such as presentation layer 744. In these systems, the application/module “logic” can be separated from the aspects of the application/module that interact with a user.

Some software architectures utilize virtual machines. In the example of FIG. 7, this is illustrated by virtual machine 748. A virtual machine creates a software environment where applications/modules can execute as if they were executing on a hardware machine (such as the machine of FIG. 8, for example). A virtual machine is hosted by a host operating system (operating system 714 in FIG. 7) and typically, although not always, has a virtual machine monitor 746, which manages the operation of the virtual machine as well as the interface with the host operating system (i.e., operating system 714). A software architecture executes within the virtual machine such as an operating system 750, libraries 752, frameworks/middleware 754, applications 756 or presentation layer 758. These layers of software architecture executing within the virtual machine 748 can be the same as corresponding layers previously described or may be different.

In the example embodiment, the central listings engine 150 operates as an application in the applications 720 layer. However, in some embodiments, the central listings engine 150 may operate in other software layers, or in multiple software layers (e.g., framework 718 and application 720), or in any architecture that enables the systems and methods as described herein.

FIG. 8 is a block diagram illustrating components of a machine 800, according to some example embodiments, able to read instructions from a machine-readable medium (e.g., a machine-readable storage medium) and perform any one or more of the methodologies discussed herein. Specifically, FIG. 8 shows a diagrammatic representation of the machine 800 in the example form of a computer system, within which instructions 816 (e.g., software, a program, an application, an applet, an app, or other executable code) for causing the machine 800 to perform any one or more of the methodologies discussed herein may be executed. For example the instructions may cause the machine to execute the flow diagrams of FIG. 6. Additionally, or alternatively, the instructions may implement the user interactions module 210, external site communications module 220, graphing module 230, community analysis module 240, and bidding module 250, and so forth. The instructions transform the general, non-programmed machine into a particular machine programmed to carry out the described and illustrated functions in the manner described. In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 816, sequentially or otherwise, that specify actions to be taken by machine 800. Further, while only a single machine 800 is illustrated, the term “machine” shall also be taken to include a collection of machines 800 that individually or jointly execute the instructions 816 to perform any one or more of the methodologies discussed herein.

The machine 800 may include processors 810, memory 830, and I/O components 850, which may be configured to communicate with each other such as via a bus 802. In an example embodiment, the processors 810 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 812 and processor 814 that may execute instructions 816. The term “processor” is intended to include multi-core processor that may comprise two or more independent processors (sometimes referred to as “cores”) that may execute instructions contemporaneously. Although FIG. 8 shows multiple processors, the machine 800 may include a single processor with a single core, a single processor with multiple cores (e.g., a multi-core process), multiple processors with a single core, multiple processors with multiples cores, or any combination thereof.

The memory/storage 830 may include a memory 832, such as a main memory, or other memory storage, and a storage unit 836, both accessible to the processors 810 such as via the bus 802. The storage unit 836 and memory 832 store the instructions 816 embodying any one or more of the methodologies or functions described herein. The instructions 816 may also reside, completely or partially, within the memory 832, within the storage unit 836, within at least one of the processors 810 (e.g., within the processor's cache memory), or any suitable combination thereof, during execution thereof by the machine 800. Accordingly, the memory 832, the storage unit 836, and the memory of processors 810 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) or any suitable combination thereof. The term “machine-readable medium” should be taken to include a single medium or multiple media (e.g., a centralized or distributed database, or associated caches and servers) able to store instructions 816. The term “machine-readable medium” shall also be taken to include any medium, or combination of multiple media, that is capable of storing instructions (e.g., instructions 816) for execution by a machine (e.g., machine 800), such that the instructions, when executed by one or more processors of the machine 800 (e.g., processors 810), cause the machine 800 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes transitory signals per se.

The I/O components 850 may include a wide variety of components to receive input, provide output, produce output, transmit information, exchange information, capture measurements, and so on. The specific I/O components 850 that are included in a particular machine will depend on the type of machine. For example, portable machines such as mobile phones will likely include a touch input device or other such input mechanisms, while a headless server machine will likely not include such a touch input device. It will be appreciated that the I/O components 850 may include many other components that are not shown in FIG. 8. The I/O components 850 are grouped according to functionality merely for simplifying the following discussion and the grouping is in no way limiting. In various example embodiments, the I/O components 850 may include output components 852 and input components 854. The output components 852 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 854 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location or force of touches or touch gestures, or other tactile input components), audio input components (e.g., a microphone), and the like.

In further example embodiments, the I/O components 850 may include biometric components 856, motion components 858, environmental components 860, or position components 862 among a wide array of other components. For example, the biometric components 856 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 858 may include acceleration sensor components (e.g., accelerometer), gravitation sensor components, rotation sensor components (e.g., gyroscope), and so forth. The environmental components 860 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 862 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 850 may include communication components 864 operable to couple the machine 800 to a network 880 or devices 870 via coupling 882 and coupling 872 respectively. For example, the communication components 864 may include a network interface component or other suitable device to interface with the network 880. In further examples, communication components 864 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 870 may be another machine or any of a wide variety of peripheral devices (e.g., a peripheral device coupled via a Universal Serial Bus (USB)).

Moreover, the communication components 864 may detect identifiers or include components operable to detect identifiers. For example, the communication components 864 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 864, such as, location via Internet Protocol (IP) geo-location, location via Wi-Fi® signal triangulation, location via detecting a NFC beacon signal that may indicate a particular location, and so forth.

In various example embodiments, one or more portions of the network 880 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 880 or a portion of the network 880 may include a wireless or cellular network and the coupling 882 may be a Code Division Multiple Access (CDMA) connection, a Global System for Mobile communications (GSM) connection, or other type of cellular or wireless coupling. In this example, the coupling 882 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 816 may be transmitted or received over the network 880 using a transmission medium via a network interface device (e.g., a network interface component included in the communication components 864) and utilizing any one of a number of well-known transfer protocols (e.g., hypertext transfer protocol (HTTP)). Similarly, the instructions 816 may be transmitted or received using a transmission medium via the coupling 872 (e.g., a peer-to-peer coupling) to devices 870. The term “transmission medium” shall be taken to include any intangible medium that is capable of storing, encoding, or carrying instructions 816 for execution by the machine 800, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

1. A system comprising:
a community bidding engine comprising at least one processor and configured to:
generate a graph from a plurality of user interaction events between a plurality of users of a first online environment and a plurality of items presented within the first online environment, the graph including a user node for each user of the plurality of users, an item node for each item of the plurality of items, and one or more edges, each edge of the one or more edges connecting a user node with an item node;
determine a first community from the graph, the first community including a first user;
determine a bid amount for a bid request based on the first community; and
provide the bid amount for use with the bid request for serving an online content item to the first user within a second online environment of a content provider.

2. The system of claim 1, wherein the bidding engine generates the graph by performing operations including computing a first edge weight for a first edge of the one or more edges based on the plurality of user interaction events, wherein the first community is determined from the graph fur based at least in part on the first edge weight.

3. The system of claim 2, wherein the computing the first edge weight includes computing the first edge weight based on a first user interaction event involving the first user, the first user interaction event having a first user interaction event type, the first edge weight defined by a first pre-defined weight associated with the first user interaction event type.

4. The system of claim 1, wherein the bidding engine determines the bid amount based on historical revenue data associated with the first community.

5. The system of claim 1, wherein the at least one processor is further configured to:
determine a first item from the first community; and
identify the first item for retargeting to the first user through the online content item based on the bid request being won by the community bidding engine.

6. The system of claim 1, wherein the at least one processor is further configured to receive the bid request associated with the serving of the online content item to the first user, wherein the bid amount is provided by transmitting the bid amount in response to the bid request.

7. The system of claim 1, wherein the bidding engine provides the bid amount by performing operations including transmitting, prior to the bid request, a community bid mapping to an advertising system associated with the bid request, the community bid mapping identifies the first community and a first bid value associated with the first community, the first bid value identifies the bid amount.

8. A method comprising:
generating a graph from a plurality of user interaction events between a plurality of users of a first online environment and a plurality of items presented within the first online environment, the graph including a user node for each user of the plurality of users, an item node for each item of the plurality of items, and one or more edges, each edge of the one or more edges connecting a user node with an item node;
determining, by a hardware processor, a first community from the graph, the first community including a first user;
determining a bid amount for a bid request based on the first community; and
providing the bid amount for use with the bid request for serving an online content item to the first user within a second online environment of a content provider.

9. The method of claim 8, wherein generating the graph further includes computing a first edge weight for a first edge of the one or more edges based on the plurality of user interaction events, wherein determining the first community from the graph further includes determining the first community based on the first edge weight.

10. The method of claim 9, wherein computing the first edge weight includes computing the first edge weight based on a first user interaction event involving the first user, the first user interaction event having a first user interaction event type, the first edge weight defined by a first pre-defined weight associated with the first user interaction event type.

11. The method of claim 8, wherein determining a bid amount further includes determining the bid amount based on historical revenue data associated with the first community.

12. The method of claim 8 further comprising:
determining a first item from the first community; and
identifying the first item for retargeting to the first user through the online content item based on the bid request being won by the community bidding engine.

13. The method of claim 8 further comprising receiving the bid request associated with the serving of the online content item to the first user, wherein providing the bid amount includes transmitting the bid amount in response to the bid request.

14. The method of claim 8, wherein providing the bid amount includes transmitting, prior to the bid request, a community bid mapping to an advertising system associated with the bid request, the community bid mapping identifies the first community and a first bid value associated with the first community, the first bid value identifies the bid amount.

15. A machine-readable storage medium storing a set of instructions that, when executed by at least one processor, causes the at least one processor to perform operations comprising:
generating a graph from a plurality of user interaction events between a plurality of users of a first online environment and a plurality of items presented within the first online environment, the graph including a user node for each user of the plurality of users, an item node for each item of the plurality of items, and one or more edges, each edge of the one or more edges connecting a user node with an item node;
determining a first community from the graph, the first community including a first user;
receiving a bid request for serving an online content item to the first user within a second online environment of a content provider;
determining a bid amount for the bid request based on the first community; and
submitting the bid amount in response to the bid request.

16. The machine-readable medium of claim 15, wherein the generating the graph further includes computing a first edge weight for a first edge of the one or more edges based on the plurality of user interaction events, wherein determining the first community from the graph further includes determining the first community based at least in part on the first edge weight.

17. The machine-readable medium of claim 16, wherein the computing the first edge weight includes computing the first edge weight based on a first user interaction event involving the first user, the first user interaction event having a first user interaction event type, the first edge weight defined by a first pre-defined weight associated with the first user interaction event type.

18. The machine-readable medium of claim 15, wherein the determining a bid amount further includes determining the bid amount based on historical revenue data associated with the first community.

19. The machine-readable medium of claim 15, wherein the operations further comprise:
determining a first item from the first community; and
identifying the first item for retargeting to the first user through the online content item based on the bid request being won by the community bidding engine.

20. The machine-readable medium of claim 15, wherein providing the bid amount includes transmitting, prior to the bid request, a community bid mapping to an advertising system associated with the bid request, the community bid mapping identifies the first community and a first bid value associated with the first community, the first bid value identifies the bid amount.
